(19) United States
(12) Patent Application Publication
(10) Pub. No.: US 2004/0111961 A1
(43) Pub. Date: Jun. 17, 2004

(54) Holder for floral arrangement with water basin

(76) Inventor: Leigh Ann Cooper, Evansville, IN (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/729,777

(22) Filed: Dec. 4, 2003

Related U.S. Application Data
(60) Provisional application No. 60/430,472, filed on Dec. 4, 2002.

(51) Int. Cl. A01G 5/00; A47G 7/00

(52) U.S. Cl. 47/41.12

(57) ABSTRACT

A holder for floral arrangements, in particular, the type of floral holder commonly referred to as a casket saddle, and which is particularly useful for positioning the floral arrangement on top of a casket. The floral holder may further be used for holding floral arrangements for display under any other public or non-public occasions, such as weddings. The floral holder includes a body portion that includes a water-confining basin therein. Water is poured through an opening disposed on an upper portion of the body portion into the water-confining basin. A cap is positioned in sealing contact with the opening to prevent water spillage from the opening during handling or moving of the floral holder. The floral holder further includes a foam block that rests on a top surface of the body portion, and a wicking cloth. The wicking cloth having a first end sandwiched between the top surface and the foam block, and a second end that passes through a slot opening in the top surface of the body portion and is submerged into the water contained within the water basin. The stems of flowers are inserted into the moist foam block as is known in the art.

### CROSS REFERENCES TO RELATED APPLICATIONS

U.S. Provisional Application for Patent 60/430,472, filed Dec. 4, 2002, with title “Holder for floral arrangement with water basin” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention relates to holders for floral arrangements, in particular, the type of holders which are commonly referred to as casket saddles, and which are particularly useful for positioning the floral arrangement on top of a casket. The floral holder may further be used for holding floral arrangements for display under any other public or non-public occasions, such as weddings.

2. Brief Description of Prior Art

Holders for floral arrangements that require moisture after the flowers have been inserted in the holder are well known in the art As well, casket saddles which are particularly useful for positioning the floral arrangement on top of a casket are likewise well know in the art. In general, the prior art floral holders and casket saddles comprise a water impermeable, molded plastic member having a cavity, which cavity receives a water retaining block. The block is retained within the cavity by various devices, such as adhesive, tapes or a plastic film or by providing a push-fit between the blocks and the walls of the cavities. After the blocks are inserted into the cavities, water is supplied to the blocks. The holder generally has a means of draining any excess water from the holder. The stems of the flowers are then inserted into the water containing blocks which generally assist the flowers from wilting for at least a few hours, by the moisture in the blocks.

In most of the holders of the prior art, including the floral holders and casket saddles, the foam block occupies most of the upper surface of the unit, so it is very difficult to add water, if desired, without spilling some of the water. It is generally also very difficult to pick up the holder, which makes moving the floral arrangement inconvenient and which increases the likelihood of spillage.

Further, when the lower portion of the block becomes saturated, the holders of the prior art have failed to accommodate means to manage the excess water. As such, water generally flows or drips from the lower portion of the holder, which is undesirable.

Attempts have been made to reduce such undesirable water overflow, such as by using several spaced blocks in series in a cavity or by providing spaced grooves in the foam block which extend transversely the length of the block and substantially from the front face to the rear surface of the block. While such attempts have been partially successful, the problem of water overflow and spillage from the lower portion of a holder has not been overcome.

Further, as stated, the water containing blocks generally retain the moisture for only a few hours, thereafter, as the water in the block evaporates, the flowers begin to wilt and obviously lose their aesthetic appearance. Attempts have been further made to longer maintain the aesthetic appearance of the flower and therefore maintain the moisture in the block for a longer period of time. However, such problem continues with the prior art floral holders.

As will be seen from the subsequent description, the preferred embodiment of the present invention overcome limitations of existing floral holders of the prior art.

### SUMMARY OF THE INVENTION

The present invention is a holder for floral arrangements that includes a body portion, the body portion defining a water-confining basin therein into which water is poured through an opening disposed on an upper portion of the body portion, which opening is in communication with the water basin. A cap is positioned in sealing contact with the opening of the body portion to prevent water spillage from the opening during handling or moving of the floral holder. The floral holder further includes a foam block that rests on a top surface of the body portion, and a wicking cloth. The wicking cloth having a first end disposed between the top surface of the body portion and the foam block, and a second end that passes through a slot opening in the top surface and submerged within the water contained within the water-basin. Stems of flowers are inserted into the moist foam block as is known in the art.

### BRIEF DESCRIPTION OF THE DRAWINGS

FIG. 1 is a perspective view of the preferred embodiment of the present invention, a floral holder.

FIG. 2 illustrates a sectional view of the floral holder of FIG. 1.

FIG. 3 is an alternate design of the present invention.

FIG. 4 illustrates a sectional view of the floral holder of FIG. 3.

### DESCRIPTION OF THE PREFERRED EMBODIMENTS

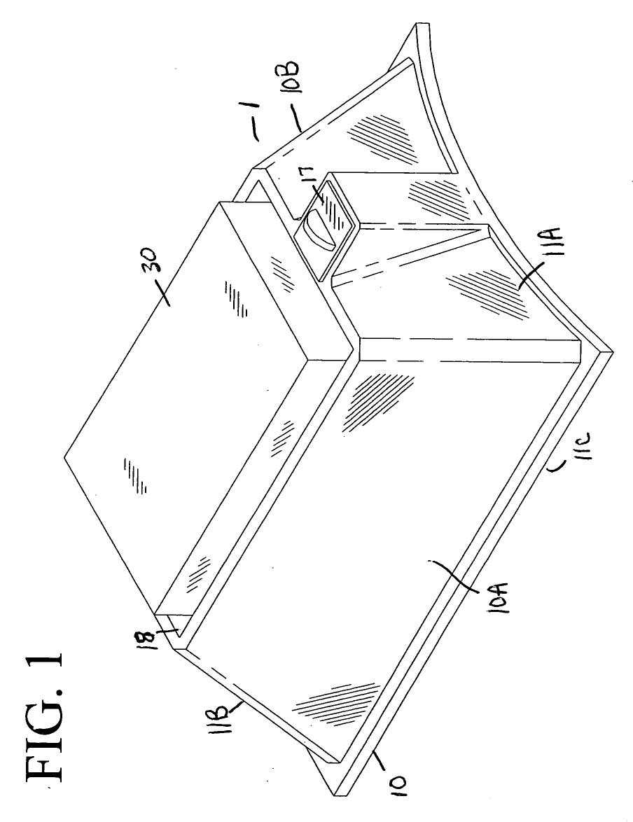

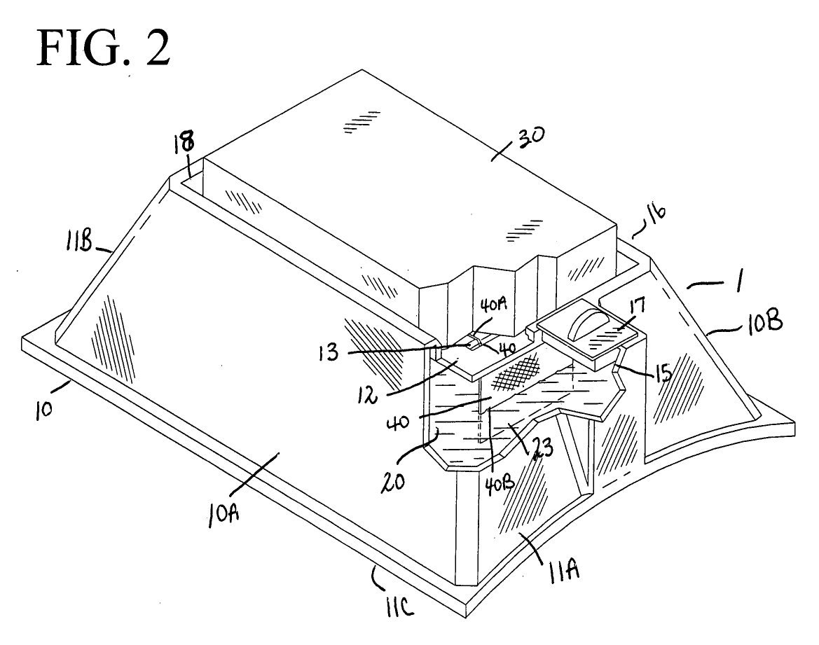

FIGS. 1-2 illustrate a preferred embodiment of a floral holder 1 made in accordance with the present invention. In the preferred embodiment, the floral holder 1 for maintaining floral arrangements of the type which are commonly referred to as casket saddles, and which are particularly useful for positioning the floral arrangement on top of a casket.

As shown, the floral holder 1 includes a body portion 10, said body portion 10 having a pair of side walls 10A and 10B, a front wall 11A, a back wall 11B, and a lower surface 11C. The side walls 10A and 10B, and front and back walls 11A and 11B, and lower surface 11C define a water-confining basin 20 within the body portion 10. The body portion 10 further includes a top surface 12 (shown in FIG. 2) appropriately attached to the walls 10A, 10B, 11A and 11B forming a water-tight seal therebetween. As shown in FIG. 2, the top surface 12 includes a slot opening 13 for access to the basin 20 as will be further described.

The body portion 10 further includes an opening 15 preferably disposed on an upper end 16, adjacent the front wall 11A and the top surface 12. In application, water 23 is poured in to the basin 20 through the opening 15, which opening 15 is in fluid communication with the basin 20. The water basin 10 is made of suitable material to hold the water 23.

A cap 17 is removably positioned in sealing contact with the opening 15 of the body portion 10 to prevent water spillage from the opening 15 during handling or moving of the floral holder 1. The opening 15 is further provided for receiving the water 23 into the water basin 20 when the cap 17 is removed. In the preferred embodiment, the opening 15 is formed integral with the body portion 10.

As best shown in FIG. 2, the top surface 12 is positioned in relation to the walls 10A, 10B, 11A and 11B to define a ledge 18 that extends the perimeter of the top surface 12.

The floral holder 1 further includes a foam block 30, which foam block 30 is known in the art, and is designed to absorb water. As will be further discussed, the foam block 30 of the present invention to continuously absorb the water 23 contained within the basin 20. The foam block 30 having a generally rectangular configuration preferably extending the approximate length and width of the top surface 12. In particular, the block 30 is preferably sized and shaped to rest on the top surface 12 of the body portion 10 within the confines of the ledge 18.

The floral holder 1 further includes a wicking cloth 40 (shown in FIG. 2), said wicking cloth 40 having a first end 40A sandwiched between the top surface 12 and the foam block 30, and a second end 40B opposite the first end 40A, said second end 40B passes through the slot opening 13 as shown in FIG. 2 and is submerged into the water 23 contained within the water basin 20. Said wicking cloth 40 made of a water absorbing material known in the art. The inventor has found it optimal when a length of approximately 9 inches of the first end 40A rests between the top surface 12 and the foam block 30, and a length of approximately 8 inches of the second end 40B is submerged in the water 23.

In application, stems of selected flowers (not shown) are inserted into the foam block 30 as is known in the art. The foam block 30 is then placed on the top surface 12 of the body portion 10 so that the first end 40A of the wicking cloth 40 is sandwiched between the foam block 30 and the top surface 12. The second end 40B of the wicking cloth 40 being submerged within the water 23 contained within the basin 20 as described above. As is understood, the wicking cloth 40 remains moist by continuously absorbing water 23 within the basin 20. The moist wicking cloth 40 remains in contact with the block 30 causing the block 30 to absorb moisture from the wicking cloth 40. As a result, the flower stems within the block 30 remain moist for a longer period of time since the block 30 maintains moisture as discussed above.

Once the block 30 having the stems of flowers inserted therein is positioned on the top surface 12, additional water can be poured into the basin 20 by removing the cap 17 and pouring the water 23 through the opening 15 into the basin 20. As such, water 23 may be added to the basin 20 without the inconvenience of removing or moving the floral arrangement.

In the event the foam block 30 becomes saturated, any excess water remains on the top surface 12 within the ledge 18 to avoid spillage. As such, the present invention includes means to manage excess water.

FIGS. 1 and 2 illustrate the application of the present invention having a substantially rectangular configuration. Of course, the present invention is applicable to holders having other shapes. With such other shapes, such as the shape of floral accessories commonly referred to as bouquet handles, the principles described in connection with FIGS. 1-2 are the same.

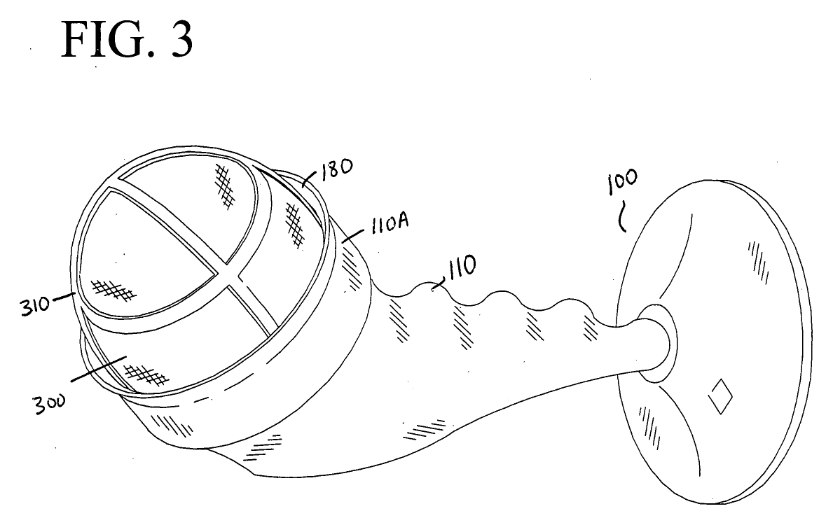

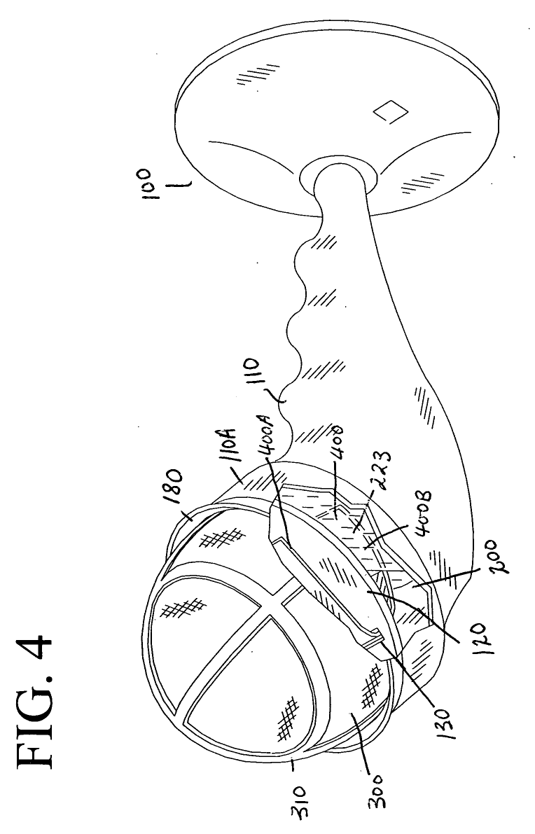

Referring to FIGS. 3 and 4, the floral holder 100 includes a body portion 110, said body portion 110 defining a water-confining basin 200 therein. The body portion 110 further includes a top surface 120 (shown in FIG. 4) appropriately attached to an upper wall 110A of the body portion 110. The top surface 120 attached to the upper wall 110A forming a water-tight seal therebetween.

As shown in FIG. 4, the top surface 120 includes a slot opening 130 for access to the basin 200. In application, water 223 can be poured through the opening 130 into the basin 200 or in the alternative, a removably sealed access means (not shown) can be disposed on the upper portion of the body portion 110, which access means is in fluid communication with the basin 200 such that water can be poured into the basin 200 through the access means.

As best shown in FIG. 4, the top surface 120 is positioned in relation to the upper wall 110A to define a ledge 180 that extends the parameter of the top surface 120.

The floral holder 100 further includes a foam block 300, the block 300 is preferably sized and shaped to rest on the top surface 120 of the body portion 100 within the confines of the ledge 180. As is known in the art, a strap 310 can be applied to hold the foam block 300 in place.

The floral holder 100 further includes a wicking cloth 400, said wicking cloth 400 having a first end 400A in communication with the foam block 300, and a second end 400B opposite the first end 400A, said second end 400B submerged within the water 223 contained within the basin 200.

In application, the basin 200 of the floral holder 100 is filled with water. The wicking cloth 400 is positioned so that the first end 400A is resting on the top surface 120 of the body portion 110, and the second end 400B passes through the slot opening 130 and is submerged into the water 223 contained within the basin 200. The foam block 300 is positioned on the top surface 120 of the body portion 100 so that the first end 400A of the wicking cloth 400 is sandwiched between the top surface 120 and the foam block 300. The strap 310 may be positioned over the foam block 300 as is known in the art in order to maintain the position of the foam block 300 on the top surface 120. Prior to inserting the stems of the flowers into the foam block 300, the foam block 300 may be saturated with water. Any excess water from the foam block 300 will be absorbed by the wicking cloth 400 and maintained within the confines of the ledge 180.

Application of the floral holder 1 according to the principles disclosed herein, will maintain the foam block 30 moist for a much longer period of time than the prior art floral holders. As a result of the foam block 30 remaining moist for an extended period of time, the flowers will likewise receive such moisture from the foam block 30 and therefore maintain their aesthetically pleasing appearance for a longer period of time. Specifically, the wicking cloth 40 will continue to absorb the water 23 within the water basin 20, said wicking cloth being in continuous moist communication with the foam block 30 as described above, and therefore the foam block 30 remains moist. When the water 23 within the water basin 20 evaporates or becomes shallow to where the second end 40B of the wicking cloth 40 is no longer submerged, additional water 23 is poured within the water basin 20 by removing the cap 17 from the opening 15 of the body portion 10, and pouring additional water 23 through the opening 15 into the basin 20. The inventor has found that the present invention will maintain continuous moisture to the foam block 30 for approximately 4 days, in comparison to approximately a few hours with the prior art.

A typical material of construction for the body portion 10 is a water impermeable, molded plastic.

Although the description above contains many specificities, they should not be construed as limiting the scope of the invention but is merely providing illustrations of some of the presently preferred embodiments of this invention.

It will be obvious to those skilled in the art that modifications may be made to the embodiments described above without departing from the scope of the present invention. Thus, the scope of the invention should be determined by the appended claims in the formal application and their legal equivalents, rather than by the examples given.

Thus the scope of the invention should be determined by the appended claims in the formal application and their legal equivalents, rather than by the examples given.

I claim:

1. A floral holder comprising:
a body portion including a pair of side walls, a front wall, a back wall, a top surface, and a lower surface, said walls and lower surface defining a water-confining basin, the body portion further including an opening adjacent the top surface;
a slot opening disposed on the top surface, said slot opening for accessing the water basin from the top surface;
a cap removably positioned in sealing contact with the opening;
a foam block removably positioned on the top surface; and
a wicking cloth having a first end in contact with the foam block, and a second end that passes through the slot opening and is submerged in the water contained in the water basin;
wherein water is poured into the basin through the opening.

2. The floral holder as recited in claim 1, wherein the opening is disposed on an upper end of the body portion.

3. The floral holder as recited in claim 1, wherein the walls define a ledge along the perimeter of the top surface.

4. The floral holder as recited in claim 3, wherein the foam block rests on the top surface within the confines of the ledge.

5. The floral holder as recited in claim 4, wherein the foam block extends the approximate length and width of the top surface.

6. The floral holder as recited in claim 1, wherein the first end of the wicking cloth is sandwiched between the top surface and the foam block.

7. A floral holder comprising:
a body portion comprising a water-confining basin disposed within the body portion;
a top surface attached to the body portion;
a slot opening disposed on the top surface;
a foam block removably positioned on the top surface; and
a wicking cloth having a first end in contact with the foam block, and a second end that passes through the slot opening and is submerged in the water contained in the water basin.

8. The floral holder as recited in claim 7, wherein the body portion further includes a pair of side walls, a front wall, and a back wall, wherein said walls define a ledge along the perimeter of the top surface.

9. The floral holder as recited in claim 8, wherein the foam block rests on the top surface within the confines of the ledge.

10. The floral holder as recited in claim 9, wherein the foam block extends the approximate length and width of the top surface.

11. The floral holder as recited in claim 7, wherein the first end of the wicking cloth is sandwiched between the top surface and the foam block.

12. The floral holder as recited in claim 7, wherein a water-tight seal is formed between the top surface and the body portion.

13. A method of arranging flowers in a floral holder including the steps of:
supplying water to a water basin of a body portion of the floral holder,
inserting stems of the flowers into a foam block,
inserting a first end of a wicking cloth through a slot opening of a top surface of the body portion until the first end is submerged in the water contained in the water basin,
laying a second end of the wicking cloth on the top surface,
resting the foam block on the top surface so that the second end of the wicking cloth is sandwiched between the top surface and the foam block

14. The method as recited in claim 13, wherein the step of supplying water to the water basin can be followed after the step of resting the foam block on the top surface.

15. The method as recited in claim 13, wherein the step of pouring water into the water basin can be followed by pouring the water through an opening disposed in the body portion, wherein the body portion further includes a cap removably positioned in sealing contact with the opening.
